(19) United States
(12) Patent Application Publication
(10) Pub. No.: US 2020/0042554 A1
(43) Pub. Date: Feb. 6, 2020

(54) Discovering and Selecting Location-Based Music

(71) Applicants: Sean Liu, Sunnyvale, CA (US); Rajeev Nayak, Sunnyvale, CA (US); Rita Chen, Forest Hills, NY (US); Andrew Theodore Wansley, San Francisco, CA (US)

(72) Inventors: Sean Liu, Sunnyvale, CA (US); Rajeev Nayak, Sunnyvale, CA (US); Rita Chen, Forest Hills, NY (US); Andrew Theodore Wansley, San Francisco, CA (US)

(73) Assignee: GOOGLE INC., Mountain View, CA (US)

(21) Appl. No.: 13/559,594

(22) Filed: Jul. 26, 2012

(51) Int. Cl. G06F 16/687; G06F 16/638

(52) U.S. Cl. CPC G06F 16/687; G06F 16/639

(57) ABSTRACT

Methods, systems, and computer programs are presented for discovering and selecting location-based music. The disclosed method includes identifying a user having a user device, determining a distance zone proximate to the user device, and identifying a group of users having respective nearby devices within the distance zone. Each of the nearby devices is in progress of playing a selected music track. Each of the identified user device and the nearby devices has access to an application for accessing online music. The disclosed method further includes generating a playlist for the user device based on examination of the selected music tracks being played by the users and forwarding the generated playlist to the user device.

### BACKGROUND

Internet applications have grown tremendously over the years and so has the functionality provided to devices that access those applications. One area that has seen such growth relates to audio file management. An audio file management application may enable a user to search and purchase music selections online and store the purchased music in cloud storage. The audio file management application may further enable a user to access and play the music stored in the cloud storage using network connected devices.

Playlist generation is a common task, which users conduct to organize their music. However, compiling the proper mix of music for a playlist can be a time consuming process. This is especially true when the playlist is designed to include music for a unique group of users at a specific location. It is in this context that embodiments arise.

### SUMMARY

Embodiments of the present disclosure provide methods, systems, and computer programs for discovering and selecting location-based music. It should be appreciated that the present disclosure can be implemented in numerous ways, such as a process, an apparatus, a system, a device, or a method on a computer readable medium. Several inventive embodiments of the present disclosure are described below.

In one embodiment, a method for discovering and selecting location-based music is disclosed. The method includes identifying a user having a user device. The user device has access to an application for accessing online music. The disclosed method further includes determining a distance zone around the user device and identifying a group of nearby users having respective nearby devices within the distance zone. The nearby devices of the nearby users have access to respective applications for accessing online music. Each of the nearby devices is in the progress of playing a selected music track. Based on examination of the selected music tracks being played by the nearby devices, a playlist is generated for the user device, and the generated playlist is forwarded to the user device.

In another embodiment, a system including a server for executing logic is disclosed. The disclosed logic identifies a user device having access to an online music service over a network, determines a distance zone around the user device, and identifies a group of nearby devices within the distance zone. The identified nearby devices have access to the online music service, and each of the nearby devices is in progress of playing a selected music track using the online music service. The disclosed logic further automatically generates a playlist for the user device based on examination of music tracks being played by the nearby devices, and forwards the generated playlist to the user device. The playlist is generated based on a current location of the user device, the distance zone, and the group of nearby devices.

Other aspects will become apparent from the following detailed description, taken in conjunction with the accompanying drawings.

### BRIEF DESCRIPTION OF THE DRAWINGS

The disclosure may best be understood by reference to the following description taken in conjunction with the accompanying drawings.

FIG. 1 illustrates a system diagram for enabling access and playing of music files stored in cloud music storage, in accordance with one embodiment of the present disclosure.

FIG. 2 illustrates how user A utilizes a device (e.g. smartphone) to access his or her music account stored in the cloud music storage, in accordance with one embodiment of the present disclosure.

FIG. 3 illustrates a system diagram for discovering location-based music, in accordance with one embodiment of the present disclosure.

FIGS. 4(A) and 4(B) illustrate changes of the nearby devices for a group of nearby users over time, in accordance with one embodiment of the present disclosure.

FIG. 5 illustrates changes of a user device over time, in accordance with one embodiment of the present disclosure.

FIG. 6 illustrates an example method of requesting a location-based playlist and an example method of sending a “shout out” message for a music track being played by a nearby user, in accordance with one embodiment of the present disclosure.

FIG. 7 illustrates a two-dimensional diagram showing the music trends for a shopping mall during the time of a day, in accordance with one embodiment of the present disclosure.

FIG. 8 illustrates a flow diagram of an example method for discovering location-based music, in accordance with one embodiment of the present disclosure.

FIG. 9 is a simplified schematic diagram of a computer system for implementing embodiments of the present disclosure.

### DETAILED DESCRIPTION

Methods and systems are described for discovering music for automatically generating playlists based on a user device's location. In one embodiment, the disclosed methods include identifying a user having a user device and calculating or determining a distance zone around or within a proximity of the user device. The user device has an application or code for accessing online music. Based on the calculated distance zone, a group of nearby users having respective nearby devices within the distance zone is identified, and each of the nearby users is playing a selected music track. A disclosed method includes generating a playlist based on selected music tracks being played by the nearby users, and presenting the playlist to the user device. In one embodiment, the transmitting of the generated playlist may be based on a push action by a server or based upon the user's request (e.g., based on a user's selection on a user interface of the user device). In one embodiment, the processing of the playlist generation is conducted on a server or multiple servers of a music service provider. The playlist is presented to the user device on a user interface (UI) that is at least partially populated with data by the music service provider. In such an embodiment, the user receives the playlist on the user device that has network access to the music service provider and is therefore able to render the UI on the user device.

The following description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in a simple block diagram format in order to avoid unnecessarily obscuring the present disclosure. Thus, the specific details set forth are merely examples. Particular implementations may vary from these example details and still be contemplated to be within the spirit and scope of the present disclosure.

Reference in the description to “one embodiment” or “an embodiment” means that a particular feature, structure, or characteristic described in connection with the embodiment is included in at least one embodiment of the disclosure. The appearances of the phrase “in one embodiment” in various places in the specification do not necessarily all refer to the same embodiment.

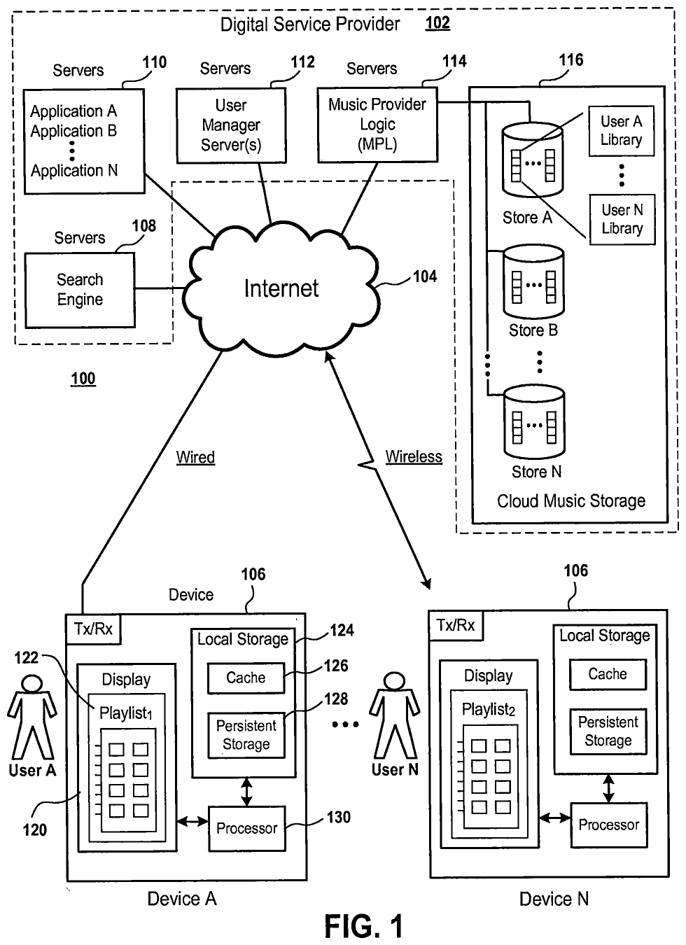

FIG. 1 illustrates a system diagram 100 for enabling access and playing of music files stored in a cloud music storage, in accordance with one embodiment of the present disclosure. The system 100 includes a plurality of servers that are connected to the Internet 104. The plurality of servers and storage are, in one embodiment, part of a digital service provider 102. The digital service provider 102, is a system that can include a plurality of servers that can provide applications, services, digital content, and interconnectivity between systems, applications, users, and social networks. For example, the digital service provider 102 can include a search engine 108, a plurality of servers 110 that provide applications for various business, social, and technology related subject matter, servers that provide user management 112, and servers to provide music related services 114.

One example digital service provider 102 can be Google Inc., of Mountain View California. Other digital service providers can be more focused to provide only specific services, while others provide a variety of services for access, download, viewing, searching, etc. The content can vary greatly, but is commonly presented in digital format and displayed on monitors or screens of devices, computers, smartphones, tablets, etc.

The servers that provide music related services, in one embodiment, are illustrated by the music provider logic 114, that executes over one or more servers that are connected to the Internet 104. The music provider logic 114 is shown connected to a cloud music storage 116. Cloud music storage 116 is shown to include a plurality of storage systems, identified as store A, store B, . . . store N. The various storage systems that hold music data and music metadata, are provided with fast access to the Internet, for providing music data on demand to users requiring access to their music accounts stored in cloud music storage 116. In one embodiment, users can access the cloud music storage 116 by way of a plurality of devices 106. The plurality of devices can include any type of device having a processor and memory, wired or wireless, portable or not portable. In the example illustrated in FIG. 1, user A is shown to have device 106 (device A). Device 106 is shown to include communication logic for transmitting and receiving data between device 106 and the Internet 104.

The communication logic (Tx/Rx) can include various types of network interface circuitry, radio-communication (e.g. wireless), cell tower communication, or interconnected wiring connected to Internet service providers. Device 106 is also shown to include a display having a screen 120, local storage 124, and a processor 130. Local storage 124 can include cash memory 126, persistent storage 128, and other logic. In this example, device 106 is shown to include graphical icons (e.g., graphical user interfaces GUIs) that represent a play list. The screen 120 can be a touch-screen, or a display typically provided by a flat-panel display, a cathode ray tube (CRT), or other media capable of rendering a display. Still further, device 106 can have its display separate from the device, similar to a desktop computer or a laptop computer. Still further yet, device 106 can be in the form of a smartphone, a tablet computer, or hybrids that provide touch screen capability in a portable form factor. One example device can include a portable phone device that runs an operating system and is provided with access to various applications (apps) that may be obtained over the Internet, and executed on the local portable device (e.g., smartphone, tablet, laptop, desktop, etc.).

In one embodiment, the user of device 106 can install an application that provides cloud storage of music files, and access to the storage cloud music files from the device 106. Once the user's music files are uploaded to the cloud music storage 116, the user's music files are associated to a library of the user. In one embodiment, a plurality of users can access the same application and can upload their own music files to create their own library, which will be stored in the cloud music storage 116.

Each of such users can then access the cloud music storage 116 through an application on their device 106 to render and play selected music files on their device, when the device 106 has access to the Internet and associated servers of the music provider logic 114 and cloud music storage 116. Accordingly, users can access the music application on their device 106, access all music files stored in cloud music storage 116, arrange music titles in their music library into playlists, add music to the cloud music storage 116, delete music from the cloud music storage 116, and purchase music that is added to the cloud music storage 116. These changes are maintained and managed by the music provider logic 114 and the music provider logic 114 will provide access to the various users to their music files stored in the cloud music storage 116, based on their selections during use of the application.

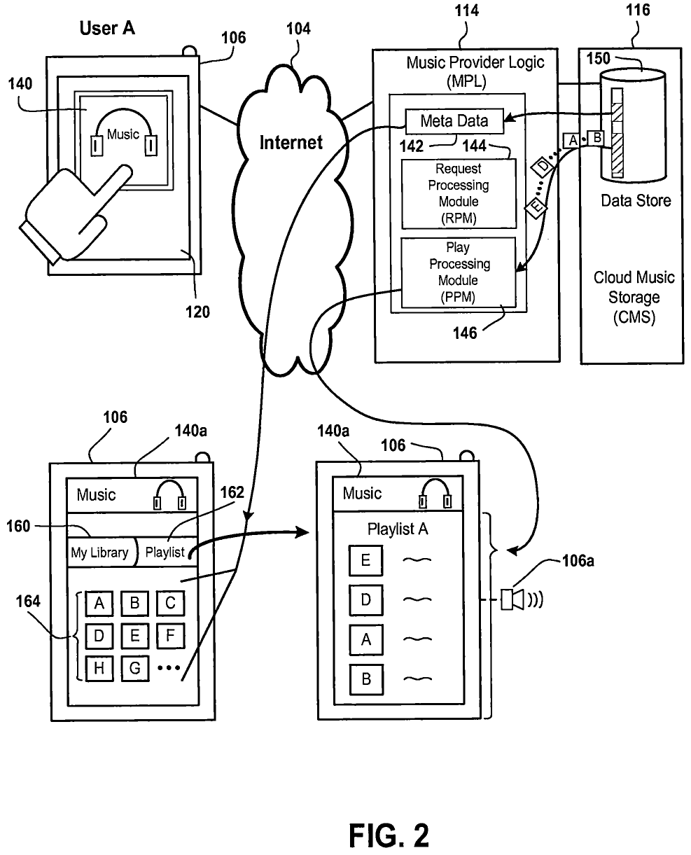

FIG. 2 illustrates how user A utilizes a device 106 (e.g. smartphone) to access his music library stored in the cloud music storage (CMS) 116, in accordance with one embodiment of the present disclosure. As shown, the device 106 will include a screen 120, and associated graphical icons that present a thumbnail of an application 140, associated with a music application. Application 140, as described herein, relates to an application that provides a user with access to his or her music library which has been previously added to the cloud music storage 116. If the user is a new user to the application 140, the new user can download application 140 to device 106 from at least one server 110 of the digital service provider 102.

Once the application 140 has been downloaded and installed on device 106, the icon representing application 140 will be rendered on the display screen of device 106. Initially, the user will be prompted to select music to add to the cloud music storage 116. The music may be added from files currently maintained by the user on his or her device 106, on other devices of the user such as computers, other smartphone and or tablets, or other storage media. Additionally, the user can add music files that may be part of a music library maintained by another application. The other application may maintain a specific format for the music, and the music can be obtained and translated to standardize music files for addition to the cloud music storage 116.

Once the user has managed his library to add, modify, or adjust the music files present in the cloud music storage 116, the user can access application 140 and various options from graphical user interfaces provided on the screen 120 of device 106. In the illustrated example, device 106 will open application 140 through various graphical user interface screens, such as interface 140a. Interface 140a can include various menus, selection icons, configuration icons, displays, advertisements, buttons, listings, etc. In this example, the interface 140a may include an image that lists the users library 160, the users playlists 162, and music title icons 164. Music title icons can be represented by graphical artwork that represents artwork associated with the various music files present in the users library. The users library is illustrated by music title icons 164, shown as A-H.

The music title icons 164 are rendered on the screen 120 upon obtaining metadata from the cloud music storage 116 (or accessing the metadata from previous download(s) stored locally on the user device), which may be present in data store 150. Music provider logic 114 will include request processing module 144 that manages the requests and communication between various users applications 140 and the cloud music storage 116. The request processing module (RPM) 144 is also in communication with a play processing module (PPM) 146. In order to render the title icons 164 on the screen of the device 106, the music provider logic 114 will utilize the request processing module 144 to obtain metadata 142 from the data store 150.

The metadata 142 will be the metadata associated with the various music files stored in data store 150. The metadata 142 provides information regarding each of the titles stored in the cloud music storage 116, and sufficient information to render the title icons 164 on the screen of device 106, and provides text information, duration information, genre information, and other data that describes aspects or characteristics of the music files. As shown, when the user selects playlist 162 on device 106, a playlist graphical user interface is shown identifying particular songs that have been arranged by the user.

Playlist A, part of the playlist 162, represents various songs that were selected by the user. The user can have various playlists, and the selection of playlist A is only provided as one example of a playlist that includes music files that are played in the order EDA B. Once the user selects a corresponding play button or clicks on one of the audio files in the playlist, the music files will begin to play, via the speaker 106a, in the order arranged and defined by the user in his or her playlist A.

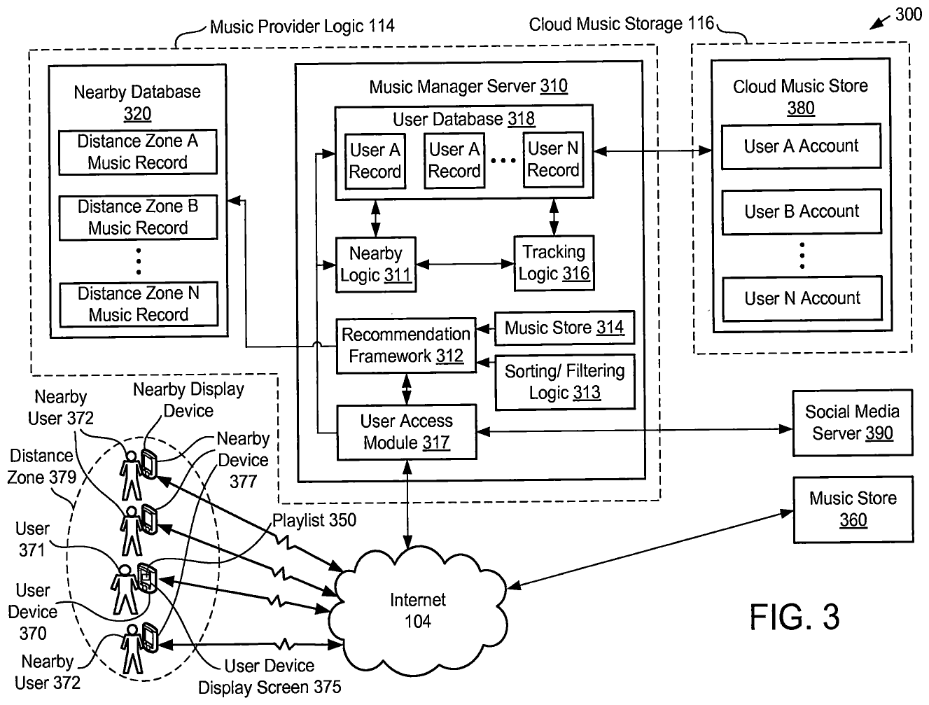

FIG. 3 illustrates a system diagram 300 for discovering location-based music, in accordance with one embodiment of the present disclosure. The system 300 includes a music manager server 310, a nearby database 320, a music store 360, a cloud music store 380, and a social media server 390.

In one embodiment, the music manager server 310 and the nearby database 320 are part of the music provider logic 114, and the cloud music store 380 is part of the cloud music storage 116, as shown in FIG. 1. In other embodiments, the music manager server 310 and the nearby database 320 may be defined from separate processing systems. For example, the music manager server 310 may be stored in a separate processing system to be accessed by users over the internet 104, and the nearby database 320 may be stored in a storage managed by a separate server that works in conjunction with or in coordination with the music provider logic 114. In one embodiment, a network of servers operate to process logic that enables location identification of devices and automatic generation of playlists. One embodiment consists of having separate dedicated serviers identify location and location parameters, while other dedicated servers process the automatic generation of playlists. In still other embodiments, both functions can be processed by a single server or group of distributed servers.

As shown in FIG. 3, the music manager server 310 includes nearby logic 311, a recommendation framework 312, sorting/filtering logic 313, a music store 314, tracking logic 316, a user access module 317, and a user database 318. The user access module 317 may be used to handle a user's music account login request and to communicate the user login information to the user database 318. In one embodiment, the user access module 317 has access to a social media server 390 that maintains a plurality of social network user profiles. Providing access to a user's social network may, for example, allow social interaction and sharing with social network friends. This may include sharing user likes, dislikes or comments, or music preferences with social network friends. In one embodiment, this sharing can include sharing of playlist comments regarding the music itself, comments about artists, song styles, preferences, etc. The social information can also be shared in the user's social network streams or circles, during live chats, or video chats. Although FIG. 3 illustrates one user and three nearby users within a distance zone who may access the services provided by the music manager server 310, it is to be understood that in practice, many more users may access the services provided by the music manager server 310, and the service can be widely distributed across networks.

In the example illustrated in FIG. 3, user 371 has a user device 370 and each of nearby users 372 has a nearby device 377. The user device 370 has an application or code for accessing online music and the online user music account, and so does each of the nearby devices 377. In one embodiment, after user 371 has logged into his or her user account online, the user access module 317 will send the user login information to the user database 318. The user database 318 may be used to store a plurality of user records with each user record being associated with a user or a nearby user. Each user record stored in the user database 318 may document a user's music online activities, such as the user's music account login status, the information related to the music track being played by the user, the user's music collections, created playlists, favorite songs, play counts for each song in the user's music collection, etc.

In one embodiment, the user database 318 communicates with the cloud music store 380 so that the various user accounts stored in the cloud music store 380 may be updated. The nearby logic 311 and the tracking logic 316 may communicate with the user database 318 to identify which user or nearby user has logged into his or her music account, and whether he or she is playing a music track. In one embodiment, the tracking logic 316 may track the locations of the users (with user permission) who have logged into their respective user accounts by tracking the locations of the user devices of those users. In other embodiments, the tracking logic 316 may obtain location data from other tracking services, or location identifying services. For example, location identifying services may include, without limitation, signal processing from a cellular towers, GPS processors, Wi-Fi signals, IP address resolution processors, etc.

In one embodiment, after user 371 has logged into his or her music account, user 371 may send a request for discovering location-based music, e.g., the music tracks being played by other nearby users, to the nearby logic 311 of the music manager server 310 via the user access module 317. Upon receiving the user's request, the nearby logic 311 may identify user 371 who sent out the request and the location of user 371 by obtaining the location of the user device 370 via the location data received from the tracking logic 316. In one embodiment, the tracking logic 316 may utilize the service from Google Latitude or signals from a cellular tower, GPS, Wi-Fi, IP address tracking to track and update the location of a user device or a nearby device for a user or a nearby user who has logged into his or her music account.

In one embodiment, based on the location of the user device 370, the nearby logic 311 may calculate or determine a distance zone 379 around the user device 370. The distance zone may have either a two-dimensional or three-dimensional space location or volume. In the example shown in FIG. 3, the circular distance zone 379 is calculated using the location of the user device 370 as the center of the circular distance zone 379 and the radius of the circular distance zone 379 may be determined based on pre-defined rules. Although the distance zone 379 shown in FIG. 3 is circular in shape, it is to be understood that the distance zone could be in any regular or irregular shape. In another embodiment, the distance zone 379 may be defined by obtaining the location data of the user device 370 and the nearby devices 377 from one or more location identifying services.

In one embodiment, a distance zone around a user device may be defined by dimensions of structural buildings, such as a shopping mall, a church, a school, etc. In another embodiment, a distance zone around a user device may be more generally defined, such as within an approximate city block, or within a certain radius or zone. In still another embodiment, a distance zone may be relative to a map address. A three-dimensional distance zone may also include identification of vertical space. Vertical space may be useful if the distance zone relates to identifying the floor or approximate floor in a multi-floor building.

Based on the calculated distance zone, the nearby logic 311 is further configured to identify a group of nearby users having respective nearby devices within the distance zone, and each of nearby users is playing a music track from their respective music collections. In the embodiment shown in FIG. 3, there are three nearby users 372 having their respective nearby devices 377 within the distance zone 379, and each of the nearby users 372 is playing a selected music track from a respective nearby device 377.

In one embodiment, the nearby logic 311 may send the information regarding the identified user, the identified group of nearby users, and the music tracks being played by nearby users to the recommendation framework 312. Based on the received information sent by the nearby logic 311, the recommendation framework 312 may generate a playlist 350 for user 371. In one embodiment, the generated playlist includes all music tracks being played by nearby users.

In the example illustrated in FIG. 3, the generated playlist 350 may be sorted and/or filtered by the sorting/filtering logic 313. In one embodiment, the sorting/filtering logic 313 may sort and/or filter the generated playlist 350 based on the social affinity defined by social network profiles of user 371 and nearby users 372. For example, the playlist 350 may be sorted and/or filtered based on whether nearby users 372 are the social network friends of user 371 so that user 371 can have the knowledge of what his or her nearby friends are listening to. In another example, the playlist 350 may be sorted and/or filtered based on whether user 371 and nearby users 372 come from the same hometown, which are documented in the social network profiles of user 371 and nearby users 372. In yet another example, the playlist 350 may be sorted and/or filtered based on whether user 371 and nearby users 372 work in the same or similar fields, which may also be obtained from the social network profiles or data of user 371 and nearby users 372.

In another embodiment, the generated playlist 350 may be sorted and/or filtered by music affinity defined by the music listening history of user 371 (and users nearby). The music listening history may include the categories of music user 371 listened to, the singers or the artists user 371 liked, etc. In other embodiments, the music affinity may be defined by the music listening histories of user 371 and/or his or her social network friends. In one embodiment, if a nearby user is the user's social network friend, the nearby user's identification may be listed along with the music track being played by the nearby user.

In one embodiment, upon receiving the generated playlist 350 in the user device 370, user 371 may choose one or more favorite music tracks from the playlist 350 and sends out the “shout outs” messages to the nearby users who are playing those favorite music tracks or one nearby. A “shout out” message may indicate the user's likes or dislikes for the music track being played. A “shout out” message for a favorite music track may be transmitted from the user device 370 to the nearby device 377 of the nearby user who is playing that favorite music track. In one embodiment, the nearby user who received the “shout out” message may send out a response to user 371. The response message sent by the nearby user may show the identification of the nearby user, if the nearby user's identification has not been revealed, to user 371. Thus, the “shout out” feature may be utilized as social means to meet new friends who like the same type of music.

In one embodiment, the playlist 350 generated by the recommendation framework 312 may be presented to the user device 371. For example, after the recommendation framework 312 has generated the playlist 350 for user 371, the playlist 350 may be presented to the user device 370 to be displayed at the user device display screen 375. In another example, the playlist 350 may be presented via the user access module 317 to the UI used by the user device 370 to access the music service online.

In one embodiment, the nearby logic 311 and the tracking logic 316 may record the music tracks being played for a specified distance zone based on a time line with or without a user's request, and send the gathered information to the recommendation framework 312. For example, the nearby logic 311 may work in conjunction with the tracking logic 316 to record all music tracks being played by the shoppers in a shopping mall, and sends the recorded location-based music playing information to the recommendation framework 312. In one embodiment, the recommendation framework 312 may send the received location-based music playing information to the nearby database 320 to be saved in a music record based on the specified distance zone.

The saved location-based music playing information in a distance zone music record of the nearby database 320 may be used to show the music trends for that specified distance zone. In one embodiment, the saved location-based music playing information may be categorized according to music types and be displayed based on the music categories and time line. For example, the time line in the display may be hours in a day, days in a month, months in a year, etc.

In one embodiment, the recommendation framework 312 may be configured to recommend music tracks to user 371 based on the generated playlist 350. The recommended music tracks may be purchased from the online music store 314 or from an external music store 360 provided by another music provider.

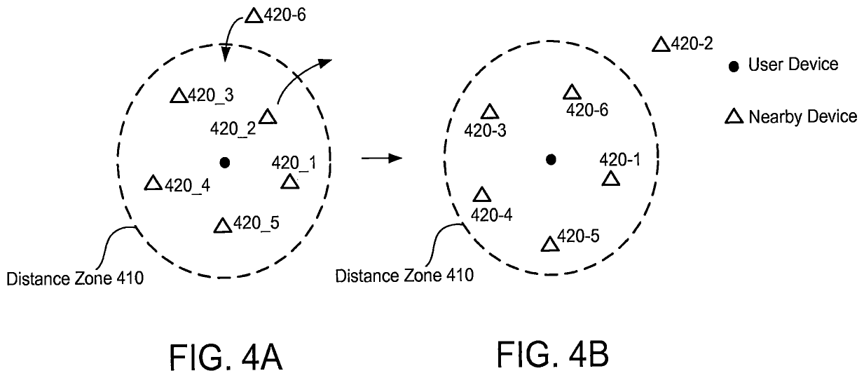

FIGS. 4(A) and 4(B) illustrate changes of the nearby devices for a group of nearby users over time, in accordance with one embodiment of the present disclosure. In FIGS. 4(A) and 4(B), the distance zone 410 around the user device 450 is shown in dash lines. Although the two-dimensional distance zone 410 in FIG. 4(A) and FIG. 4(B) is circular in shape, it is to be understood that a distance zone around a user device may have a three-dimensional space and may be defined in other shapes not shown in FIG. 4.

FIG. 4(A) shows the initial position of nearby users in the distance zone 410. As illustrated, in additional to the user device 450, there are five nearby devices 420_1, 420_2, 420_3, 420_4, and 420_5 within the distance zone 410. The nearby device 420_6 is outside of the distance zone 410. Because each nearby device is associated with one nearby user, as nearby users move around, the locations of the nearby devices change accordingly. The arrows in FIG. 4(A) show the movement direction of the nearby devices 420_2 and 420_6.

As shown in FIG. 4(B), after the nearby user associated with the nearby device 420_2 moves out of the distance zone 410 and the nearby user associated with the nearby device 420_6 moves into the distance zone 410, an updated group of nearby users having the nearby devices (420_1, 420_3, 420_4, 420_5, and 420_6) are identified within the distance zone 410 around the user device 450. In one embodiment, the identification of the updated group of nearby users having respective nearby devices may be performed by the nearby logic 311, of the music manager server 310 of the music provider logic 114.

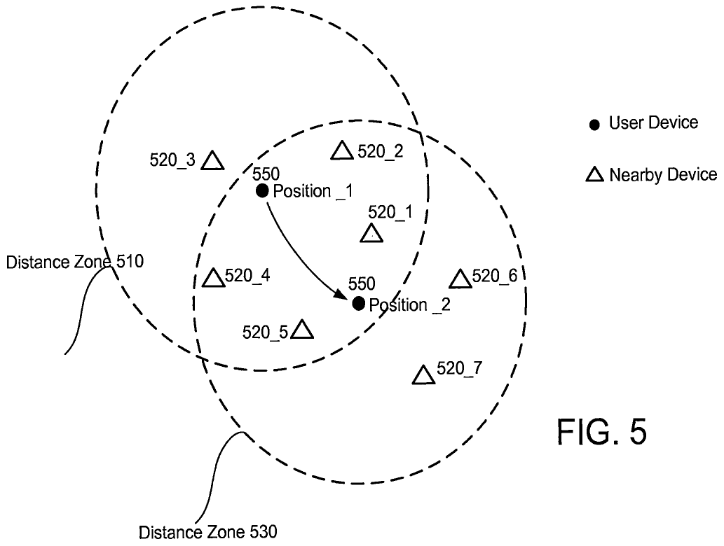

FIG. 5 illustrates changes of a user device over time, in accordance with one embodiment of the present disclosure. As shown, in this embodiment, the user device 550 has moved from position_1 to position_2. When the user device 550 is in position_1, the calculated distance zone is distance zone 510 and there are five nearby devices 520_1, 520_2, 520_3, 520_4, and 520_5 within the distance zone 510. As the user device 550 moves from position_1 to position_2, the distance zone around the user device 550 is recalculated to obtain the distance zone 530. Accordingly, an updated group of nearby users having the nearby devices (520_1, 520_2, 520_4, 520_5, 520_6, and 520_7) is identified. In one embodiment, the identification of the updated group of nearby users having respective nearby devices is performed by the nearby logic 311, of the music manager server 310 of the music provider logic 114.

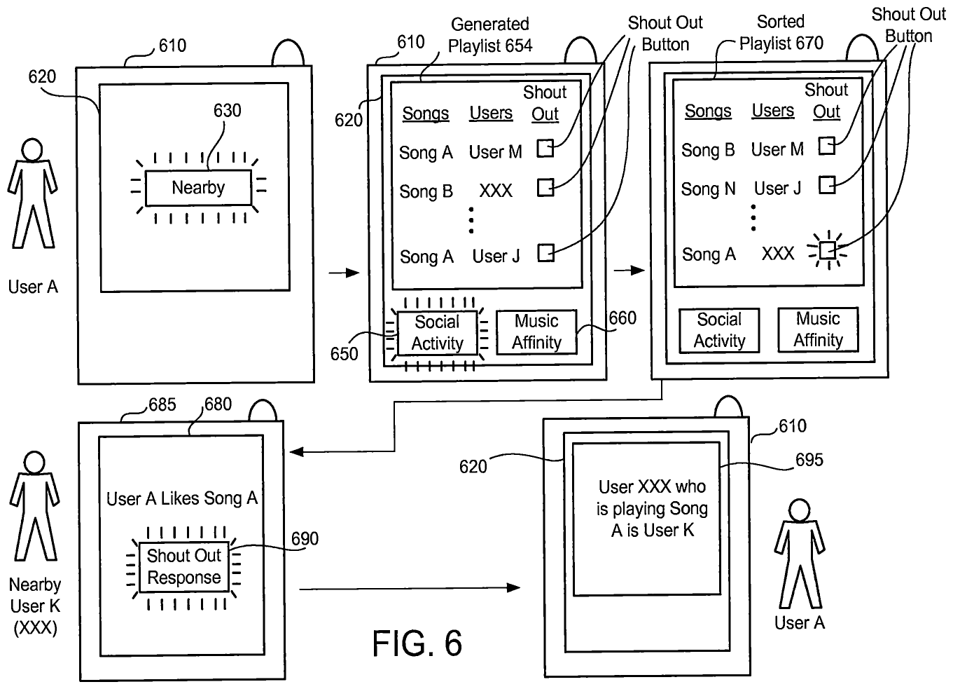

FIG. 6 illustrates an example method of requesting a location-based playlist and an example method of sending a “shout out” message for a music track being played by a nearby user, in accordance with one embodiment of the present disclosure. As shown, the user device 610 of user A includes a user device display screen 620. In one embodiment, user A may request a location-based playlist by clicking a nearby button 630 in the user device display screen 620. The nearby button 630 may be presented by the music service provider via the UI used by user A to log into his or her online music user account.

In one embodiment, after user A presses the nearby button 630 displayed on the user device display screen 620, a location-based music discovery request is sent to the corresponding music service provider, e.g., the music provider logic 114 shown in FIG. 3. For example, the nearby logic 311 of the music manager server 310 may process user A′s request for location-based music discovery and calculate a distance zone around the user device 610 based on the current location of the user device 610. The nearby logic 311 may identify one or more nearby users. The recommendation framework 312 may generate a playlist based on the music tracks being played by the identified nearby users and the user access module 317 may be used to present the generated playlist 640 to the user device display screen 620.

In one embodiment, the generated playlist 640 may include a song column showing a list of songs being played by the identified nearby users, a user column showing the identifications of the nearby users, and a “shout out” column showing the associated “shout out” buttons for the songs in the playlist 640.

In one embodiment, in addition to the generated playlist 640, user A may be presented with a social affinity button 650 and a music affinity button 660 so that user A may sort and/or filter the generated playlist 640 based on either the social affinity or the music affinity. In other embodiments, the playlist sorting/filtering feature may be implemented by a drop down menu selection, or other suitable means.

In the embodiment shown in FIG. 6, the social button 650 is pressed by user A so that the generated playlist 640 may be sorted based on social affinity to become the sorted playlist 670. The social affinity may be defined based on user A's social network connections. In this embodiment, because nearby user M and nearby user J are user A′s social network friends, the songs being played by nearby user M and nearby user J are shown in the top of the sorted playlist 670. In another embodiment, the generated playlist 640 may be sorted by a combination of the social affinity and music affinity.

In one embodiment, if user A favors song A being played the anonymous user xxx (nearby user K), user A may click on the “shout out” button associated with song A being played by nearby user K. The “shout out” message sent by user A may indicate that user A likes song A being played by nearby user K. Additionally, the “shout out” message may show the identification of user A. After nearby user K receives the “shout out” message sent by user A, nearby user K has the option to respond or not to respond to the “shout out” message sent by user A. After nearby user K clicks on the shout out response button 690 shown in the nearby device display screen 680 of the nearby device 685, a shout out response 695 is sent from nearby user K to user A and the shout out response 695 may show the identification of nearby user K to user A.

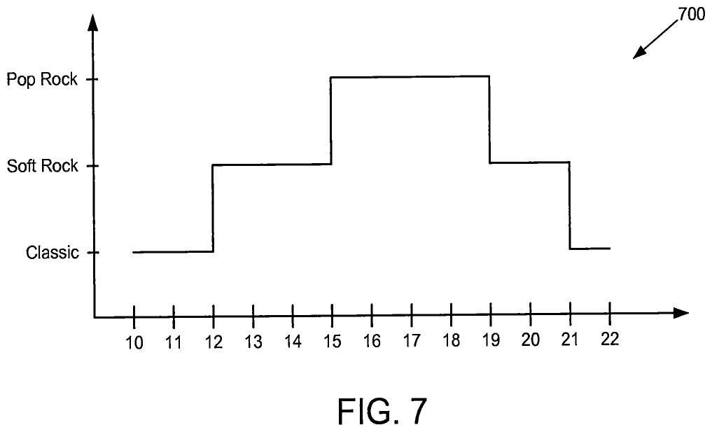

FIG. 7 illustrates a two-dimensional diagram 700 showing the music trends for a shopping mall during the time of a day, in accordance with one embodiment of the present disclosure. In this embodiment, it is assumed the shopping mall opens at 10 a.m. in the morning and closes at 10 p.m. at night. In one embodiment, the diagram 700 shown in FIG. 7 is based on data from a music record for the shopping mall stored in the nearby database 320 shown in FIG. 3. For example, the recommendation framework 312 in FIG. 3 may obtain the music being played during the operation hours of the shopping mall from the nearby logic 311, categories the music, and stores the categorized music for the shopping mall in a music record in the nearby database 320. In one embodiment, the data inside a music record may be retrieved by the recommendation framework 312 to be displayed to the user device in a two-dimensional diagram, as the diagram 700 shown in FIG. 7. It is to be understood that although, in the embodiment shown in FIG. 7, the categories of music being played during the operation hours of the shopping mall are shown based on the hours of a day, the music data stored in a music record in the nearby database 320 may be shown in any suitable means, such as three-dimensional diagrams, pie/bar graphs, etc.

As shown in FIG. 7, from 10:00 a.m. to 12:00 p.m., the type of music being played by majority of the nearby users inside the shopping mall, e.g., the shoppers, is classical music. From 12:00 p.m. to 15:00 p.m., the type of music being played by majority of the nearby users inside the shopping mall is soft rock. From 15:00 p.m. to 19:00 p.m., the type of music being played by majority of the nearby users inside the shopping mall is pop rock, possibly due to a gathering of young people in and around the shopping mall in after school hours. From 19:00 p.m. to 21:00 p.m., the type of music being played by majority of the nearby users inside the shopping mall is soft rock. During the last hour of the shopping mall operation, the type of music being played by majority of the nearby users is classical music.

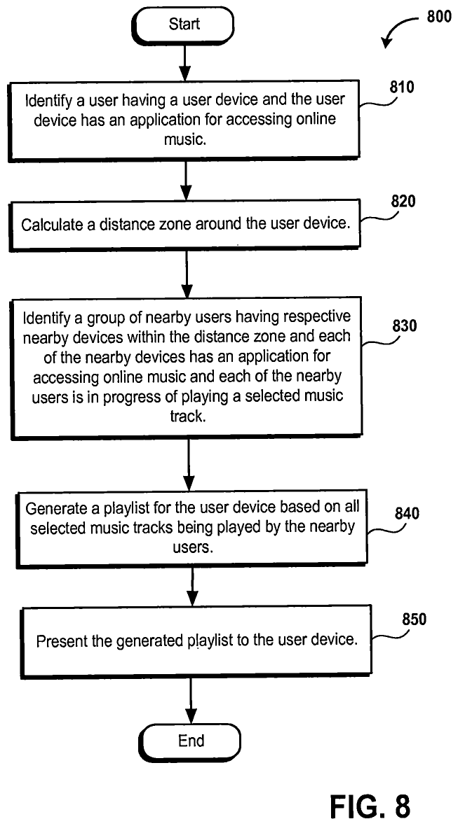

FIG. 8 illustrates a flow diagram of an example method 800 for discovering location-based music, in accordance with one embodiment of the present disclosure. In one embodiment, the illustrated example method 800 is described in relation to operations performed by the music provider logic 114, as shown in FIG. 3.

As used herein, the term “music provider logic” is used to connote a system that can manage the musical recommendation and playlist generation for users. As such, so long as the functionality is provided, any name may be provided for “music provider logic.”

In operation 810, a user having a user device is identified. The user device has an application or code for accessing online music. In one embodiment, the identification of the user having a user device includes identifying the location of the user device. For example, the identification of the user having the user device may be performed by the nearby logic 311 by receiving the location data (with user permission) of the user device from the tracking logic 316, as shown in FIG. 3.

In operation 820, a distance zone around or proximate to the user device is calculated or determined. The calculated distance zone may be either two-dimensional or three-dimensional in space. In one embodiment, a distance zone around a user device may be defined by dimensions of structural buildings, such as a shopping mall, a church, a school, etc. In another embodiment, a distance zone around a user device may be more generally defined, such as within an approximate city block, or within a certain radius or zone. In still another embodiment, the distance zone may be calculated based on the location data from the user device and other nearby devices. For example, the location data may be obtained from the tracking logic 316 of the music manager server 310 in FIG. 3. In one embodiment, the distance zone may be calculated by the nearby logic 311 of the music manager server 310 in FIG. 3.

In operation 830, a group of nearby users within the distance zone is identified. Each of the nearby users has a nearby device having the application or code for accessing online music, and each of the nearby users is in progress of playing a selected music track. In one embodiment, the identification of the nearby users having respective nearby devices may be performed by the nearby logic 311 of the music manager server 310 in FIG. 3.

In operation 840, a playlist is generated for the user device based on all of the selected music tracks being played by the nearby users. In one embodiment, the playlist is generated by the recommendation framework 312 after receiving the information regarding the selected music tracks being played by the nearby users from the nearby logic 311.

In one embodiment, the playlist may include a list of music tracks being played by the nearby users via their respective nearby devices. The playlist may further include a list of nearby users who are in progress of playing the selected music tracks. For example, the playlist may show the identification of the nearby users who are social network friends of the user, while the identification of the other nearby users who are not social network friends of the user may be blocked out.

In one embodiment, the playlist may further include a list of “shout out” buttons with each “shout out” button corresponding to each music track listed in the playlist. If the user likes a music track being played by a nearby user, the user may click on the “shout out” button associated with this music track to deliver a “shout out” message to the nearby user who is playing that music track. The nearby user who is playing that music track may choose to respond to the “shout out” message. The response sent by the nearby user may reveal the identification of the nearby user. In this way, the “shout out” message may be utilized as social means for meeting new friends. In one embodiment, the generated playlist may be sorted and/or filtered based on social affinity, music affinity, or a combination of the social affinity and music affinity.

In operation 850, the generated playlist may be presented to the user device. In one embodiment, the presentation of the playlist to the user device may be performed by the user access module 317 of the music manager server 310 in FIG. 3.

In one embodiment, the distance zone may be recalculated based on device location changes that occur over time when the user device is detected to have moved or when the nearby devices are detected to have exited or entered distance zone. Once the distance zone have been recalculated due to device location changes, a updated group of nearby users having respective nearby devices within the recalculated distance zone may be identified and the generated playlist may be updated based on music tracks being played by the updated group of nearby users. In one embodiment, the updated playlist may be presented to the user device when the difference between the updated playlist and the playlist exceeds a threshold. In one embodiment, the recalculation of the distance zone and the identification of an updated group of nearby devices may be performed by the nearby logic 311 of the music manager server 310 in FIG. 3.

The disclosed method 800 may be implemented by a central music server system in music provider logic, e.g., the music manager server 310 of the music provider logic 114 in FIG. 3. Alternatively, the disclosed method 800 may be implemented by a system having the peer to peer service. For example, a user may hear a music track, stored in a nearby device of a nearby user, being broadcasted by the nearby user. In this example, the user device of the user may be equipped with the software and hardware, functioning similarly as the music manager server 310, to calculate a distance zone around the user device and to identify a group of nearby users within the distance zone so that a playlist based on the music tracks being played by the nearby users may be generated.

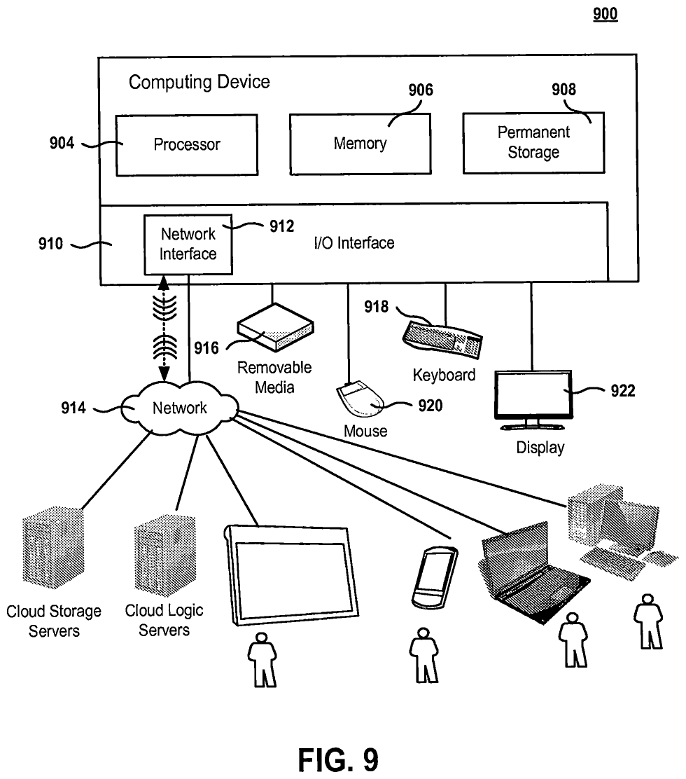

FIG. 9 is a simplified schematic diagram of a computer system 900 for implementing embodiments of the present disclosure. FIG. 9 depicts an example computer environment for implementing embodiments of the disclosure. It should be appreciated that the methods described herein may be performed with a digital processing system, such as a conventional, general-purpose computer system. Special purpose computers, which are designed or programmed to perform only one function, may be used in the alternative. The computer system 900 includes a processor 904, which is coupled through a bus to memory 906, permanent storage 908, and Input/Output (I/O) interface 910.

Permanent storage 908 represents a persistent data storage device such as a hard drive or a USB drive, which may be local or remote. Network interface 912 provides connections via network 914, allowing communications (wired or wireless) with other devices. It should be appreciated that processor 904 may be embodied in a general-purpose processor, a special purpose processor, or a specially programmed logic device. Input/Output (I/O) interface 910 provides communication with different peripherals and is connected with processor 904, memory 906, and permanent storage 908, through the bus. Sample peripherals include display 922, keyboard 918, mouse 920, removable media device 916, etc.

Display 922 is configured to display the user interfaces described herein. Keyboard 918, mouse 920, removable media device 916, and other peripherals are coupled to I/O interface 910 in order to exchange information with processor 904. It should be appreciated that data to and from external devices may be communicated through I/O interface 910. Embodiments of the disclosure can also be practiced in distributed computing environments where tasks are performed by remote processing devices that are linked through a wired or a wireless network.

Embodiments of the present disclosure can be fabricated as computer readable code on a non-transitory computer readable storage medium. The non-transitory computer readable storage medium holds data which can be read by a computer system. Examples of the non-transitory computer readable storage medium include permanent storage 908, network attached storage (NAS), read-only memory or random-access memory in memory module 906, Compact Discs (CD), Blu-ray™ discs, flash drives, hard drives, magnetic tapes, and other data storage devices. The non-transitory computer readable storage medium may be distributed over a network-coupled computer system so that the computer readable code is stored and executed in a distributed fashion.

Additionally, FIG. 9 shows various types of devices that can connect to the network, such as the internet. The devices include servers, tablet computers, smartphones, laptops, desktops, etc. The various devices run operating systems and the operating systems can vary from manufacturer to manufacturer.

Some, or all operations of the method presented herein are executed through a processor, such as processor 904 of FIG. 9. Additionally, although the method operations were described in a specific order, it should be understood that some operations may be performed in a different order, when the order of the operations do not affect the expected results. In addition, other operations may be included in the methods presented, and the operations may be performed by different entities in a distributed fashion, as long as the processing of the operations is performed in the desired way.

In addition, at least one operation of some methods performs physical manipulation of physical quantities, and some of the operations described herein are useful machine operations. Embodiments presented herein recite a device or apparatus. The apparatus may be specially constructed for the required purpose or may be a general purpose computer. The apparatus includes a processor capable of executing the program instructions of the computer programs presented herein.

Although the foregoing embodiments have been described with a certain level of detail for purposes of clarity, it is noted that certain changes and modifications can be practiced within the scope of the appended claims. Accordingly, the provided embodiments are to be considered illustrative and not restrictive, not limited by the details presented herein, and may be modified within the scope and equivalents of the appended claims.

What is claimed is:

1. A method for selecting location-based music, comprising:
receiving, by a music manager server, a request from a user device to login to a user account associated with a user, the users device having access to an application for accessing online music;
identifying, by the music manager server, music tracks associated with the user account, wherein each of the music tracks was added to a collection by the user of the user device;
determining, by the music manager server, a distance zone proximate to the user device, the distance zone defined by radius of a circle or a sphere centered about a location of the user device:
a radius of a circle or a sphere centered about the location of the user device;
identifying, by the music manager server, a plurality of nearby user accounts having respective nearby devices within the distance zone that are currently logged onto the application for accessing online music and that are currently listening to a music track from a respective collection using the application;
retrieving, from a database of the music manager server, information that identifies the music tracks being played using the application executing on the nearby devices;
generating, by the music manager server, a playlist for the user device that includes at least the music tracks being played using the application executing on the nearby devices;
forwarding, by the music manager server to the user device, a user interface that includes the playlist, wherein the user interface is configured to concurrently display a plurality of combinations, each combination having an identifier of a corresponding music track, an identifier of a corresponding nearby user, and a corresponding button, the corresponding button configured to send, from the user device, a first message to a user device of the corresponding nearby user, wherein the identifier of the corresponding nearby user is inhibited from being presented in the user interface in response to determining that the corresponding nearby user does not have an established relationship with the user of the user account and
in response to receiving a response to the first message from the user device of the corresponding nearby user, updating, by the music manager server, the user interface to reveal the identifier of the corresponding nearby user.

2. The method of claim 1, wherein the distance zone is based on location data from the user device and the nearby devices.

3. The method of claim 1, further comprising:
redetermining the distance zone based on location changes of the user device.

4. The method of claim 3, wherein the location changes occur over time when the user device is detected to have moved or when the nearby devices are detected to have exited or entered the distance zone.

5. The method of claim 3, further comprising:
identifying an updated group of nearby devices within a redetermined distance zone.

6. The method of claim 5, further comprising:
updating the playlist for the user device based on updated music tracks being played by the updated group of nearby devices.

7. The method of claim 6, further comprising:
forwarding an updated playlist to the user device when a difference between the updated playlist and the playlist exceeds a threshold.

8. The method of claim 1, further comprising:
identifying a music track from the playlist that is most listened to and is automatically identified as a favorite music track; and
sending a second message to a nearby user who is playing the favorite music track or has the favorite music track in his music library.

9. The method of claim 8, further comprising:
receiving, from the nearby user, a response to the second message.

10. The method of claim 1, further comprising:
pre-sorting the playlist by an affinity.

11. The method of claim 10, wherein the affinity is a social affinity obtained from social network data.

12. The method of claim 10, wherein the affinity is a music affinity calculated from a music listening history.

13. The method of claim 1, wherein the distance zone is defined by a two-dimensional location or a three-dimensional space.

14. A system, comprising:
a music manager server configured to:
receive a request from a user device to login to a user account associated with a user, the users device having access to an application for accessing online music
identify music tracks associated with the user account, wherein each of the music tracks was added to a collection by the user of the user device;
determine a distance zone around the user device, the distance zone defined by radius of a circle or a sphere centered about a location of the user device;
identify a plurality of nearby user accounts having respective nearby devices within the distance zone that are currently logged onto the application for accessing online music and that are currently listening to a music track from a respective collection using the application;
retrieve, from a database of the music manager server, information that identifies the music tracks being played using the application executing on the nearby devices;
generate automatically a playlist for the user device that includes at least the music tracks being played using the application executing on the nearby devices;
forward, to the user device, a user interface that includes the playlist, wherein the user interface is configured to concurrently display a plurality of combinations, each combination having an identifier of a corresponding music track, an identifier of a corresponding nearby user, and a corresponding button, the corresponding button configured to send, from the user device, a first message to a user device of the corresponding nearby user, wherein the identifier of the corresponding nearby user is inhibited from being presented in the user interface in response to determining that the corresponding nearby user does not have an established relationship with the user of the user account and
in response to receiving a response to the first message from the user device of the corresponding nearby user, update the user interface to reveal the identifier of the corresponding nearby user.

15. The system of claim 14, wherein the server is further configured to sort the playlist for the user device based on a historical use of the online music service through the user device.

16. The system of claim 14, wherein the server is further configured to be networked to a first one or more servers to provide execution of the online music service and a second one or more servers to identify a location of the user device.

17. The system of claim 14, wherein the server is further configured to execute logic to update the playlist based on devices entering or leaving the distance zone around the user device.

18. The system of claim 14, wherein the server is further configured to execute logic to update the playlist based on changes to music tracks being listened to during a time frame when the playlist is generated.

19. A non-transitory computer-readable medium comprising computer-executable instructions for managing an ordering of media items that, in response to execution by a computer device, cause the computing device to perform operations, comprising:
receiving a request from a user device to login to a user account associated with a user, the users device having access to an application for accessing online music;
identifying music tracks associated with the user account, wherein each of the music tracks was added to a collection by the user of the user device;
determining a distance zone proximate to the user device, the distance zone defined by radius of a circle or a sphere centered about a location of the user device:
identifying a plurality of nearby user accounts having respective nearby devices within the distance zone that are currently logged onto the application for accessing online music and that are currently listening to a music track from a respective collection using the application;
retrieving, from a database, information that identifies the music tracks being played using the application executing on the nearby devices;
generating a playlist for the user device that includes at least the music tracks being played using the application executing on the nearby devices;
forwarding, to the user device, a user interface that includes the playlist, wherein the user interface is configured to concurrently display a plurality of combinations, each combination having an identifier of a corresponding music track, an identifier of a corresponding nearby user, and a corresponding button, the corresponding button configured to send, from the user device, a first message to a user device of the corresponding nearby user, wherein the identifier of the corresponding nearby user is inhibited from being presented in the user interface in response to determining that the corresponding nearby user does not have an established relationship with the user of the user account and
in response to receiving a response to the first message from the user device of the corresponding nearby user, updating, using the music manager server, the user interface to reveal the identifier of the corresponding nearby user.

20. The non-transitory computer-readable medium of claim 19, the operations further comprising:
redetermining the distance zone based on location changes of the user device.

21. The non-transitory computer-readable medium of claim 20, wherein the location changes occur over time when the user device is detected to have moved or when the nearby devices are detected to have exited or entered the distance zone.

22. The method of claim 1, wherein at least two users are identified by the music management server as belonging to the group of users if at least one message is communicated between the at least two users indicating at least one user sentiment for at least one of the music tracks being played.

23. The system of claim 14, wherein at least two users are identified by the music management server as belonging to the group of users if at least one message is communicated between the at least two users indicating at least one user sentiment for at least one of the music tracks being played.

24. The non-transitory computer-readable medium of claim 19, wherein at least two users are identified as belonging to the group of users if at least one message is communicated between the at least two users indicating at least one user sentiment for at least one of the music tracks being played.

25. The method of claim 31, wherein the social affinity includes at least one of a hometown of the user and the group of users of a field of work of the user and the group of users.

26. The method of claim 1, further comprising:
determining, by the music manager server, that a user device that is playing a particular music track is a nearby device of a particular user, the particular user and the user being members of a social network; and
including, by the music manager server and in the playlist, an identification of the particular user with an identification of the particular music track.

27. The system of claim 32, wherein the social affinity includes at least one of a hometown of the user and the group of users or a field of work of the user and the group of users.

28. The system of claim 14, wherein the server is further configured to:
determine that a user device that is playing a particular music track is a nearby device of a particular user, the particular user and the user being members of a social network; and
include, in the playlist, an identification of the particular user with an identification of the particular music track.

29. The non-transitory computer-readable medium of claim 33, wherein the social affinity includes at least one of a hometown of the user and the group of users or a field of work of the user and the group of users.

30. The non-transitory computer-readable medium of claim 19, the operations further comprising:
determining that a user device that is playing a particular music track is a nearby device of a particular user, the particular user and the user being members of a social network; and
including, in the playlist, an identification of the particular user with an identification of the particular music track.

31. The method of claim 1, further comprising:
filtering, by the music manager server, the playlist based on at least one of a social affinity and a music affinity, the social affinity determined from social network profiles of the user and the group of users, the music affinity determined from music listening histories of the user and the group of users.

32. The system of claim 14, wherein the server is further configured to filter the playlist based on at least one of a social affinity and a music affinity, the social affinity determined from social network profiles of the user and the group of users, the music affinity determined from music listening histories of the user and the group of users.

33. The non-transitory computer-readable medium of claim 19, the operations further comprising:
filtering the playlist based on at least one of a social affinity and a music affinity, the social affinity determined from social network profiles of the user and the group of users, the music affinity determined from music listening histories of the user and the group of users.
